(19) United States
(12) Patent Application Publication
(10) Pub. No.: US 2007/0200302 A1
(43) Pub. Date: Aug. 30, 2007

(54) Tool-holder chuck for fitting to a rotating machine

(75) Inventor: Yves Marie Marcel Cachod, Levier (FR)

Correspondence Address: OLIFF & BERRIDGE, PLC, P.O. BOX 19928, ALEXANDRIA, VA, 22320, US

(73) Assignee: ETABLISSEMENTS AMYOT S.A, PONTARLIER (FR)

(21) Appl. No.: 11/708,602

(22) Filed: Feb. 21, 2007

(30) Foreign Application Priority Data
Feb. 23, 2006 (FR) 06/01598

(51) Int. Cl. B23B 31/12

(52) U.S. Cl. 279/60

(57) ABSTRACT

Tool-holder chuck for fitting to a rotating machine The invention relates to a tool-holder chuck for fitting to a rotating machine, comprising: a front clamping portion comprising a first axial recess, designed to receive a tool, opening to the outside at a first end for insertion of the tool and delimited, at a second end, by a first bottom wall, the front clamping portion also comprising means for clamping the tool, a rear portion comprising a second axial recess designed for engaging a rotating spindle, opening to the outside at a first end for engaging the spindle and delimited by a second bottom wall at a second end, the first and second bottom walls being traversed by an opening connecting the first and second recesses.

The invention relates to a tool-holder chuck for fitting to a rotating machine, especially a drill.

### BACKGROUND OF THE INVENTION

The tool-holder chucks that are usually used comprise:
a front clamping portion comprising a first axial recess, designed to receive a tool, opening to the outside at a first end for insertion of the tool and delimited, at a second end, by a first bottom wall, the front clamping portion also comprising means for clamping the tool,
a rear portion comprising a second axial recess designed for engaging a rotating spindle, opening to the outside at a first end for engaging the spindle and comprising a second bottom wall at a second end.

The second recess is also tapped over at least a portion of its length, the rotating spindle comprising a matching threaded portion, designed to interact with the second recess to attach the tool-holder chuck to the spindle.

Such an assembly, although ensuring a correct hold when the spindle rotates in the direction of tightening the chuck onto the spindle, often allows the appearance of unscrewing when the user desires to reverse the direction of rotation of the spindle.

This phenomenon is accentuated when the chuck is fitted with a screwing fitting and the chuck is used to unscrew a screw.

In order to prevent such a phenomenon, it is a known practice to make an axial opening passing through each of the first and second bottom walls, thus connecting the first and second axial recesses. A screw, whose head presses on the first bottom wall, traverses the orifice and comes to interact, on its threaded portion, with a tapped hole made axially in the machine spindle that is engaged in the second recess.

Thus, the screw resists the loosening of the chuck and of the spindle when the latter rotates in the unscrewing direction.

However, in the case of high-powered machines, the axial forces applied to the screw during unscrewing may break the latter so that the hold of the chuck on the spindle is no longer ensured. The chuck then unscrews from the spindle and unscrewing work is no longer possible. It is then necessary to overdimension the locking screw, causing an increase in the dimensions of the chuck and spindle assembly.

### SUMMARY OF THE INVENTION

The object of the present invention is therefore to remedy these disadvantages by proposing a tool-holder chuck capable of holding the spindle, irrespective of the direction of rotation of the latter, even for high-powered machines.

Accordingly, the invention relates to a tool-holder chuck for fitting to a rotating machine, comprising:
a front clamping portion comprising a first axial recess, designed to receive a tool, opening to the outside at a first end for insertion of the tool and delimited, at a second end, by a first bottom wall, the front clamping portion also comprising means for clamping the tool,
a rear portion comprising a second axial recess designed for engaging a rotating spindle, opening to the outside at a first end for engaging the spindle and delimited by a second bottom wall at a second end, the first and second bottom walls being traversed by an opening connecting the first and second recesses,
a screw traversing this opening, the threaded portion of the screw being engaged in an axial tapping of the spindle of the machine, while the head of the screw presses against the bottom wall of the first recess,

wherein the second axial recess comprises, from the second bottom wall to its first open end, a first zone of circular section and then a second zone of noncircular section, these two zones being designed to receive matching portions made on the rotating spindle of the machine.

These zones of circular section center the chuck relative to the rotating spindle.

The whole of the rotary movement of the spindle is transmitted via zones of noncircular section, irrespective of the direction of rotation of the spindle.

In this manner, no axial force is transmitted to the screw when there is a change of rotation direction. The screw then being used only to hold the tool-holder in translation on the spindle, the axial forces remain weak, irrespective of the power of the rotating machine.

Advantageously, the noncircular zone of the second recess is of generally polygonal shape, preferably hexagonal.

This shape, that is particularly simple to produce, offers a balanced distribution of the stresses.

According to a feature of the invention, the second recess is tapped over at least a portion of its length.

This tapping is particularly designed to hold the chuck so as to make it easier to manufacture.

Preferably, the first bottom wall has the general shape of a truncated cone and is convergent in the direction of the second recess, the zone of the head of the screw pressing against the first bottom wall being of matching shape.

The conical shape of the screw head and of the bottom wall serving as its bearing surface allows the screw to be guided when the latter is inserted through the first recess and allows a better distribution of the clamping forces on the chuck, in particular preventing the clamping forces from being directed wholly along the axis of the chuck, toward the thin zone situated between the two bottom walls.

### BRIEF DESCRIPTION OF THE DRAWINGS

In any case, the invention will be well understood with the aid of the following description, with reference to the appended schematic drawing representing, as a nonlimiting example, a form of execution of this chuck.

FIG. 1 is an exploded view of a tool-holder chuck and of a matching spindle;

FIG. 2 is a view in longitudinal section of the tool-holder chuck in position mounted on the spindle.

### DESCRIPTION OF THE PREFERRED EMBODIMENT

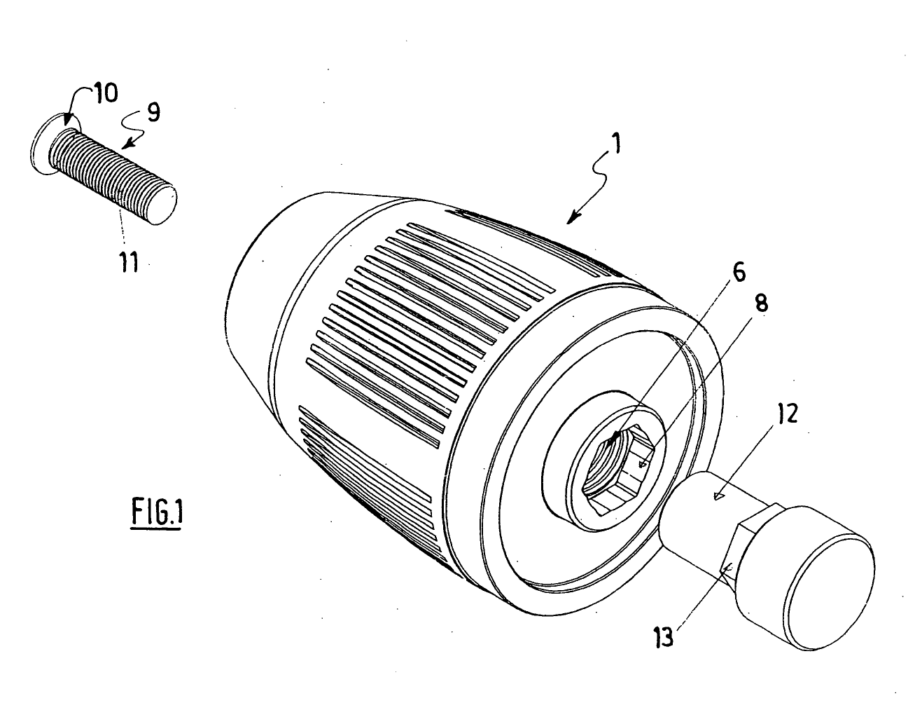

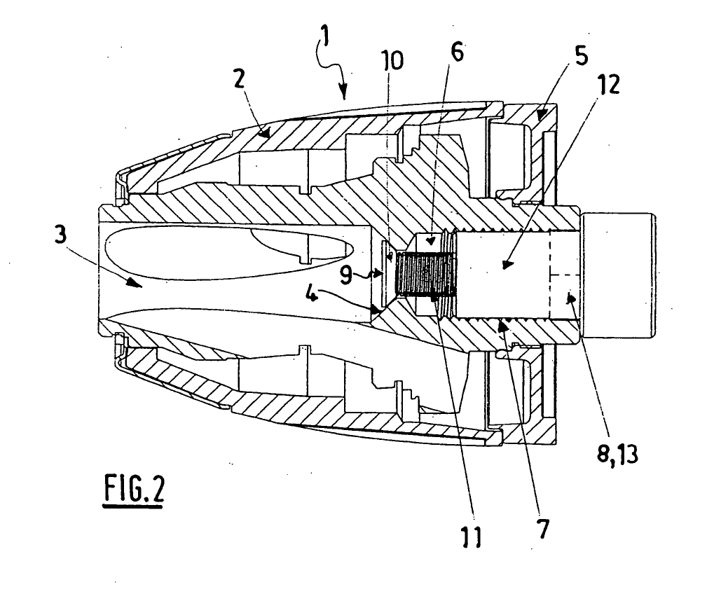

FIGS. 1 and 2 represent a tool-holder chuck 1 comprising a front clamping portion. This front portion is surrounded by a tubular casing 2 and comprises a first axial recess 3 designed to receive a tool, such as a bit or a screwing fitting. The first recess opens to the outside at a first end for inserting the tool and is delimited, at a second end, by a first bottom wall 4.

The front clamping portion also comprises means for clamping the tool, such as jaws, operated by the tubular casing 2 via a nut, the jaws and the nut not being shown in the drawing for reasons of clarity.

The chuck also comprises a rear portion surrounded by a skirt 5, the rear portion comprising a second cylindrical axial recess 6. The latter opens to the outside at a first end for engaging the spindle and is delimited by a second bottom wall at a second end.

The second recess usually comprises a tapped cylindrical portion 7 extending substantially from the corresponding bottom wall in the direction of the open end for engaging the spindle. This feature is not in line with the object of the invention but serves only to make the chuck manufacturing operations easier.

The second recess also comprises, at its first end, a zone 8 of generally hexagonal shape.

An opening passing axially through the first and second bottom walls allows a locking screw 9 to pass through. A truncated cone portion of the screw head 10 presses against the first bottom wall 4, the latter having a matching truncated cone shape and being convergent in the direction of the second recess 6.

The threaded portion 11 of the locking screw 9 then opens into the second axial recess 6.

The cylindrical end 12 of a rotating spindle of a machine of the drill type for example is engaged in the second recess 6 so as to interact with the cylindrical zone 7 of the latter.

Similarly, a hexagonal male portion 13 made on the rotating spindle interacts by matching shape with the hexagonal zone 8 of the second recess 6, this zone 8 forming the female portion of the coupling.

When the spindle is engaged, the cylindrical portion 12 of the latter is guided by the protruding portions of the tapping of the second recess 6.

In addition, the threaded portion 11 of the locking screw 9 interacts with a tapped hole made axially in the cylindrical end of the spindle.

In this manner, the locking screw 9 makes it possible to hold the spindle in the engaged position, preventing the translation of the latter into the second recess 6.

Thus, irrespective of the direction of rotation of the spindle, the movement of the tool-holder chuck 1 is wholly transmitted by the coupling of the hexagonal male portion 13 of the spindle and of the matching zone 8 of the second recess.

The screw then simply provides the locking in translation between the chuck and the rotating spindle, without playing any role in the transmission of the movement.

In this manner, the screw does not sustain axial forces with the risk of breaking it when the power of the spindle is too great.

Thus, the tool-holder chuck above makes it possible to ensure good transmission of the movement of the rotating spindle, irrespective of the direction of rotation and the power of the rotating machine.

As it goes without saying, the invention is not limited to the sole form of execution of this system described above as an example, but, on the contrary, it embraces all its variants. In this way in particular the shape of the noncircular zone of the second recess and of the matching portion made on the spindle could be different or the second recess could comprise no tapping.

1. A tool-holder chuck for fitting to a rotating machine, comprising:
a front clamping portion comprising a first axial recess, designed to receive a tool, opening to the outside at a first end for insertion of the tool and delimited, at a second end, by a first bottom wall, the front clamping portion also comprising means for clamping the tool,
a rear portion comprising a second axial recess designed for engaging a rotating spindle, opening to the outside at a first end for engaging the spindle and delimited by a second bottom wall at a second end, the first and second bottom walls being traversed by an opening connecting the first and second recesses,
a left-hand threaded screw traversing this opening, the threaded portion of the screw being designed to be engaged in an axial tapping of the spindle of the machine, while the head of the screw presses against the bottom wall of the first recess,
wherein the second axial recess comprises, from the second bottom wall to its first open end, a first zone of circular section and then a second zone of noncircular section, these two zones being designed to receive matching portions made on the rotating spindle of the machine.

2. The tool-holder chuck as claimed in claim 1, characterized in that the noncircular zone of the second recess is of generally polygonal shape, preferably hexagonal.

3. The tool-holder chuck as claimed in claim 1, wherein the second recess is tapped over at least a portion of its length.

4. The tool-holder chuck as claimed in claim 1, wherein the first bottom wall has the general shape of a truncated cone and is convergent in the direction of the second recess, the zone of the head of the screw pressing against the first bottom wall being of matching shape.

5. The tool-holder chuck as claimed in claim 2, wherein the second recess is tapped over at least a portion of its length.

6. The tool-holder chuck as claimed in claim 2, wherein the first bottom wall has the general shape of a truncated cone and is convergent in the direction of the second recess, the zone of the head of the screw pressing against the first bottom wall being of matching shape.

7. The tool-holder chuck as claimed in claim 3, wherein the first bottom wall has the general shape of a truncated cone and is convergent in the direction of the second recess, the zone of the head of the screw pressing against the first bottom wall being of matching shape.

8. The tool-holder chuck as claimed in claim 5, wherein the first bottom wall has the general shape of a truncated cone and is convergent in the direction of the second recess, the zone of the head of the screw pressing against the first bottom wall being of matching shape.
